(19) United States
(12) Patent Application Publication
(10) Pub. No.: US 2026/0358198 A1
(43) Pub. Date: Nov. 12, 2026

(54) SYSTEMS AND METHODS FOR DETECTING ENGINE OIL AERATION

(71) Applicant: Caterpillar Inc., Peoria, IL (US)

(72) Inventors: Chad F. AHMAD, Peoria, IL (US); Michael CAMPAGNA, Chillicothe, IL (US)

(73) Assignee: Caterpillar Inc., Peoria, IL (US)

(21) Appl. No.: 19/204,011

(22) Filed: May 9, 2025

(51) Int. Cl. G01M 15/05; G01K 1/02; G01K 1/024; G01K 3/00; G01K 3/14; G01K 13/02

(52) U.S. Cl. CPC G01M 15/05; G01K 1/024; G01K 1/026; G01K 3/005; G01K 3/14; G01K 13/026

(57) ABSTRACT

A system includes an internal combustion engine; an oil reservoir for supplying oil to the internal combustion engine; a first sensor disposed at the oil reservoir; a second sensor disposed at an oil flow path between the oil reservoir and the internal combustion engine; and a controller. The controller may be configured to: receive a first signal from the first sensor indicating a first temperature of the oil in the oil reservoir; receive a second signal from the second sensor indicating a second temperature of oil at a position on the oil flow path; and, based on the first signal and the second signal, determine whether an oil aeration condition exists.

### TECHNICAL FIELD

The present disclosure relates generally to systems and methods for supplying oil to an engine, and more particularly, to systems and methods for detecting aeration of engine oil.

### BACKGROUND

Engines use oil for lubrication and cooling of components, such as bearings, pistons, and crankshafts. For optimal efficiency, the properties of the engine oil, such as viscosity and thermal properties, are carefully selected. If the oil becomes aerated, e.g., if air is allowed to mix with oil, the properties of the oil and are different from the selected for and controlled properties of the oil. For example, crank dipping may cause air to enter the oil circuit of the engine and reduce the thermal efficiency of the oil and air mixture as compared to the liquid oil. Air or other gases entrained in the oil can cause the formation of air gaps or the formation and collapse of foam or bubbles sensitive to temperature and pressure.

Oil aeration contributes to reduced oil life and increased engine wear. Conventional methods for addressing oil aeration require a visual check or extracting a sample of the oil to measure a degree of aeration. These methods require stopping the operation of the engine and manual action. Existing methods do not allow for identifying oil aeration in an engine system in operation, risking oil aeration occurring and proceeding undetected until symptoms of oil aeration present themselves in the form of reduced lubricating and cooling efficiency.

U.S. Pat. No. 6,585,938, issued Jul. 1, 2023 (“the '938 patent”), discloses a device for detecting the concentration of gas in oil using two electrodes arranged in the oil such that the electrodes are opposed to each other and spaced from each other by a predetermined distance. The device in the '938 patent further includes a capacitance amplifier for outputting a signal dependent on capacitance between the electrodes, the signal being correlated to a concentration of gas in the oil. The '938 patent whether an oil aeration condition exists in the system according to temperature.

The systems and methods of the present disclosure may solve one or more of the problems set forth above and/or other problems in the art. The scope of the current disclosure, however, is defined by the attached claims, and not by the ability to solve any specific problem.

### SUMMARY

In one aspect, a system may include an internal combustion engine; an oil reservoir for supplying oil to the internal combustion engine; a first sensor disposed at the oil reservoir; a second sensor disposed at an oil flow path between the oil reservoir and the internal combustion engine; and a controller. The controller may be configured to: receive a first signal from the first sensor indicating a first temperature of the oil in the oil reservoir; receive a second signal from the second sensor indicating a second temperature of oil at a position on the oil flow path; and, based on the first signal and the second signal, determine whether an oil aeration condition exists.

In another aspect, a method of detecting engine oil aeration may include: receiving a first signal from a first sensor indicating a first temperature of oil in an oil reservoir; receiving second signal from a second sensor indicating a second temperature of oil at a position of an oil flow path; based on the first signal and the second signal, determining a temperature difference between the oil in the oil reservoir and the oil at the position on the oil flow path; and based on the temperature difference, determining whether an oil aeration condition exists in the oil.

In yet another aspect, a system may include: a first sensor configured to measure a temperature of oil in an oil reservoir; a second sensor configured to measure a temperature of oil in an oil flow path downstream of the oil reservoir; and a controller. The controller may be configured to: receive a first signal from the first sensor including a first temperature of the oil in the oil reservoir; receive a second signal from the second sensor including a second temperature of oil at a position in the oil flow path; based on the first signal and the second signal, determine a temperature difference between the oil in the oil reservoir and the oil at the position on the oil flow path; and based on the temperature difference, determine whether an oil aeration condition exists in the system.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic diagram of an engine system with oil aeration detection, according to aspects of the disclosure.

FIG. 2 provides a block diagram of a controller for the engine system of FIG. 1.

FIG. 3 provides a flowchart depicting an exemplary method for detecting oil aeration in an engine system.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

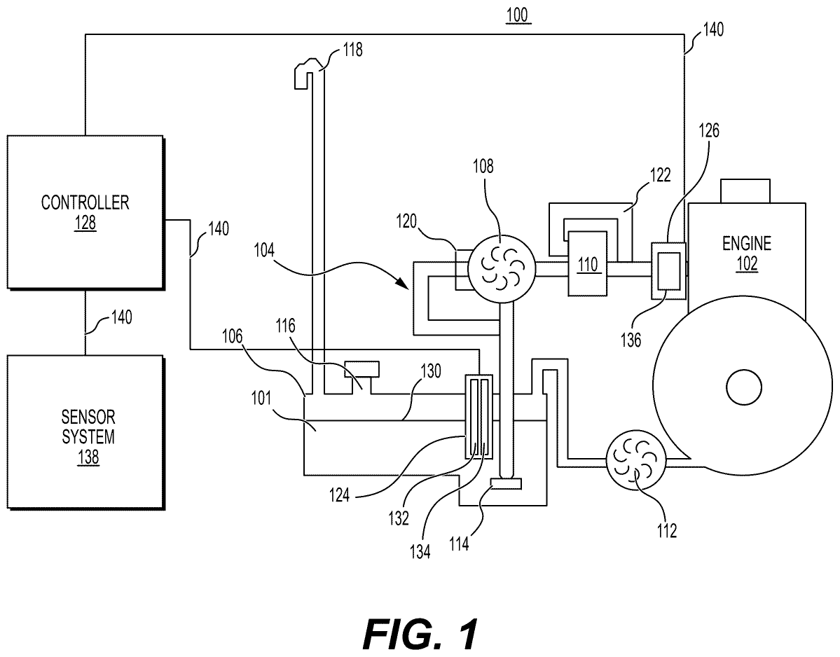

FIG. 1 is a schematic diagram of an engine system 100 for oil aeration detection, according to aspects of the disclosure. The engine system 100 may include an engine 102, such as an internal combustion engine, an oil circuit 104 for circulating oil 101 to components of the engine 102, an oil tank 106 for maintaining a reservoir of oil 101 and providing oil 101 to the oil circuit 104, a delivery pump 108 for transferring the oil 101 from the oil tank 106 to the oil circuit 104, an oil filter 110 for filtering the oil 101 before it enters the engine 102, and a scavenge pump 112 for transferring oil 101 from the oil circuit 104 back to the oil tank 106. The oil tank 106 may also include a filler 116 and a vent 118 and may support a strainer 114 through which oil enters the oil circuit 104. The delivery pump 108 may include a relief valve 120 returning oil 101 from an outlet side of the delivery pump 108 back to an inlet side of the delivery pump 108. The filter 110 may be connected to a bypass 122 for returning oil 101 from a position on the oil circuit 104 downstream of the filter 110 back to an upstream side of the filter 110.

The engine system 100 may further include one or more oil tank sensors 124 arranged at a position on the oil tank 106, one or more main gallery sensors 126 arranged at a position on the oil circuit 104, and a controller 128 configured to receive signals from the one or more oil tank sensors 124 and one or more main gallery sensors 126 via signal lines 140, and to output a signal to one or more of a display in a cabin, a notification light, or a message for a supervising system, etc. The controller 28 may be a stand-alone controller, such as an engine control module (ECM), or may be a part of a larger control unit. The controller 128 may be one or multiple physical units and may comprise units in a single housing or units in different housings. The functions performed by the controller 128 may be distributed over multiple control systems, performed partially or entirely remotely, etc.

The position on the oil tank 106 at which the first sensor 125 is secured may be a location suitable for measuring an oil level 130. The one or more oil tank sensors 124 may include an oil tank level sensor 132 for measuring the oil level 130 and an oil tank temperature sensor 134 for measuring the oil tank temperature Tₜₐₙₖ, the oil tank level sensor 132 and the oil tank temperature sensor 134 being separate sensors or a single that is configured to measure oil temperature and oil level. The oil tank temperature sensor 134 may be positioned anywhere within the oil tank 106. Conventional oil tanks may include an oil tank level sensor 132 for measuring an oil level 130 in the oil tank. For ease of modification, the oil tank temperature sensor 134 may be incorporated into an oil tank level sensor 132 to form an integrated element comprising both oil tank level sensor 132 and oil tank temperature sensor 134. In other examples, the oil tank temperature sensor may be positioned elsewhere on, in, or near the oil tank 106.

The oil tank level sensor 132 may be positioned inside a tube, in some examples. In some examples, both the oil tank level sensor 132 and the temperature sensor 134 may be positioned inside a single tube, or the oil tank level sensor 132 and temperature sensor 134 may be positioned in separate tubes. In other examples, the oil tank level sensor 132 and oil tank temperature sensor may be electronically printed onto components of the system, such as oil tank 106. For example, a portion of oil tank 106 may provide a substrate onto which conductive ink is deposited in a circuit trace to provide one or more of a temperature sensor and a conductance sensor to sense the oil level. An insulating layer may be applied to the conductive ink, thus effectively printing the oil tank level sensor 132 and the oil tank temperature sensor 134 onto the oil tank 106.

The one or more main gallery sensors 126 may include at least a main oil gallery temperature sensor 136 that measures a supply temperature T_{supply} at an inlet or supply side of engine 102. The oil tank temperature sensor 134 and the main oil gallery temperature sensor 136 may be thermocouples or other conventional temperature sensors. The position of the one or more main gallery sensors 126 on the oil circuit 104 may be at an inlet side of the engine 102, such as between the filter 110 and the engine 102.

In addition to the one or more oil tank sensors 124 and the one or more main gallery sensors 126, one or more sensors may form an additional sensor system 138 included in the engine system 100 that measures conditions associated with the engine system 100. For example, sensor system 138 may include sensors that measure ambient temperature and ambient pressure in the environment of the engine system 100, a temperature and pressure of the oil 101 at an output side of the engine 102, engine speed, intake manifold pressure, intake manifold temperature, and other conditions that impact operation of the engine 102. In examples where the engine 102 includes an engine jacket (not shown) for cooling the engine, the sensor system 138 may measure the temperature of coolant, such as water, in the engine jacket. Furthermore, sensor system 138 may measure a tilt of the oil tank 106 or of engine 102 (e.g., a measurement of inclination due to the grade of a slope that the engine system 100 may be on, to help calibrate oil level 130 measurements), and a speed of a machine (not shown) in which engine system 100 is installed, and others. These measurements may be used, along with measurements of variations in oil level 130 measurements from the oil tank level sensor 132, to retrieve expected temperature and oil level values from maps, such as values that represent a temperature difference between Tₜₐₙₖ and T_{supply} at current conditions.

At the oil tank 106, aerated oil is likely to be cooler than non-aerated oil. Because oil and air mixtures generally have a lower thermal conductivity than liquid oil, heat is transferred more slowly through aerated oil than through substantially air-free oil. Oil and air mixtures may, for example, form a foam in the oil tank 106 through which heat moves more slowly. Because foam has a larger surface area due to bubble formation, a foam will cool more quickly than non-aerated oil. Furthermore, the process of foam formation is substantially isothermal, allowing heat to dissipate as the foam is created.

At the output of the delivery pump 108, aerated oil is likely to be hotter than non-aerated oil. The delivery pump 108 may compress aerated oil, increasing the temperature of the mixture more than the temperature increase expected for non-aerated oil due to the heat introduced by compression of the gas (e.g., air) in the mixture. As such, an aerated oil mixture will tend to be hotter than non-aerated oil at the supply side of the engine 102, or T_{supply} will be greater than expected, and an aerated oil mixture will tend to be cooler than non-aerated oil at a position in the oil tank 106, or Tₜₐₙₖ will be lower than expected. Consequently, the temperature difference T_{d} where the oil is aerated will be greater than expected, where T_{d}=T_{supply}−Tₜₐₙₖ.

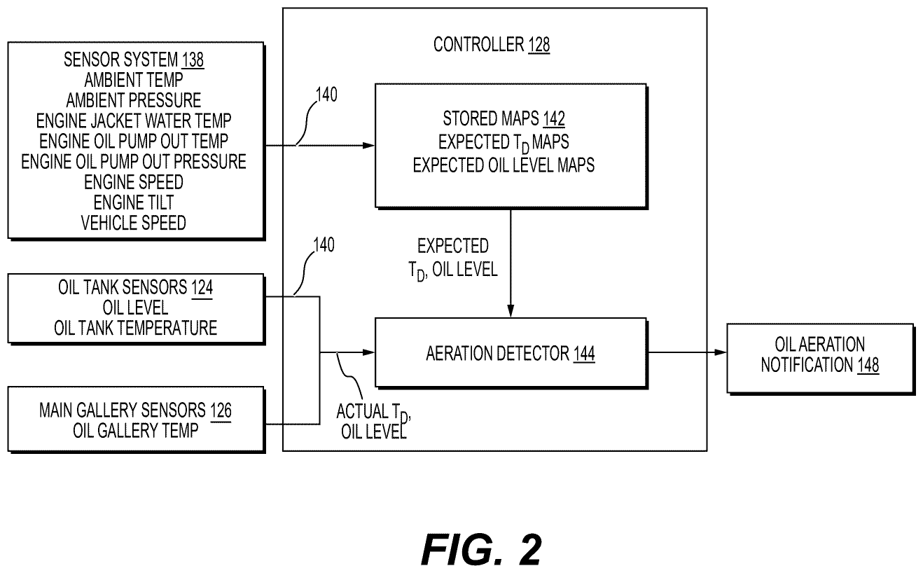

FIG. 2 is a block diagram of the controller 128 for detecting oil aeration in the engine system. The controller 128 may be configured to receive signals from the one or more oil tank sensors 124, the one or more main gallery sensors 126, and the sensor system 138 via signal lines 140 through a wired or wireless connection. The signal lines 140 may be a direct data link and/or a wireless communication link, as desired. The direct data link may include an Ethernet connection, a connected area network (CAN), or another data link known in the art. The wireless communications may include one or more of radiofrequency, cellular, Bluetooth, WiFi, infrared, or any other type of wireless communications that enables the exchange of information.

The controller 128 may include stored maps 142 for generating and storing expected temperature difference maps and, in some examples, expected oil level maps, and an aeration detector 144 for generating an aeration detection based on the measurements made at the one or more oil tank sensors 124 and the one or more main gallery sensors 126. The controller 128 may include one or more processors, sub-controllers, or field programmable gate arrays (FPGA), or a combination thereof. The controller 128 may also include, for example, a data communication interface, and a central processing unit in the form of one or more processors, for executing program instructions. The controller 128 may include an internal communication bus, and a storage unit (such as ROM, HDD, SDD, etc.) that may store data on a computer readable medium, although the controller 128 may receive programming and data via network communications. The controller 128 may have a memory (such as RAM) storing instructions for executing techniques presented herein, although the instructions may be stored temporarily or permanently within other modules of the controller 128 (e.g., the one or more processors or the computer readable medium).

The stored maps 142 may receive, from the oil tank level sensor 132 and the oil tank temperature sensor 134 included in the one or more oil tank sensors 124, a signal indicative of an oil level measurement and an oil temperature Tₜₐₙₖ at the oil tank 106, and may receive, from the one or more main gallery sensors 126, a signal indicative of an oil temperature T_{supply} at a supply side of the engine 102. The stored maps 142 may also receive, from the sensor system 138: signals indicative of ambient temperature, ambient pressure, engine coolant temperature, pump outlet oil temperature, pump outlet oil pressure, engine speed, engine tilt, and machine speed where the engine 102 is included in a mobile machine (not shown) such as an earthmoving machine, a haul truck, a paving machine, a mining machine, etc.

Stored maps 142 may have been generated based on measurements taken in a controlled environment, such as on a test bed, to correlate expected temperature values with varying degrees of aeration. The measurements may also be historical data (e.g., data taken during live operation of the engine 102). The measurements may also be input into a classification model or a machine learning model to generate the stored maps. The system may integrate machine-learning techniques to enhance its ability to predict component wear. By utilizing machine-learning techniques, vast amounts of measurement data may be analyzed to identify patterns and correlations between system measurements and expected temperature differences and oil levels. The machine-learning algorithms may be trained on historical performance data, learning to recognize how variations in operating conditions influence temperature difference. By continuously learning from both historical and real-time data, the stored maps 142 machine-learning algorithms may provide precise expected temperature differences and oil levels for a variety of conditions.

Stored maps 142 may be configured to receive, as inputs, one or more signals from sensor system 138. Maps 142 may based on this signal, retrieve an expected T_{d} value and an expected oil level value, these values being output from stored maps 142 and received by aeration detector 144. As shown in FIG. 2, stored maps 142 may retrieve these values based on one or of: ambient temperature, ambient pressure, engine coolant temperature, oil pump outlet temperature, oil pump outlet pressure, engine speed, engine tilt, and machine speed.

In some examples, expected oil level maps may be generated for expected oil level 130 in the oil tank 106. For example, the oil level 130 may be measured for a given quantity of oil in the oil tank 106 to determine an expected oil level, and may be adjusted based on engine tilt. Deviations between the measured oil level and the expected oil level 130 may be used to verify or corroborate variations in T_{d} indicative of oil aeration. In other examples, deviations from the expected oil level 130 may be independently used as indicators of oil aeration.

The aeration detector 144 may receive measurements from the one or more oil tank sensors 124, the one or more main gallery sensors 126, and the sensor system 138 to determine actual conditions based on measurements of one or more of ambient temperature, ambient pressure, engine jacket water temperature, engine outlet oil temperature, engine outlet oil pressure, engine speed, engine tilt, and vehicle speed, the difference in temperature T_{d} between the oil tank temperature Tₜₐₙₖ and the supply side temperature T_{supply}. If desired, measurements received with aeration detector 144 may be real-time measurements that indicate current conditions.

The measured temperature difference T_{d} may be compared to the expected temperature difference to determine a degree of temperature deviation. The degree of deviation may be indicative of an amount of oil aeration detected by the aeration detector 144.The measured temperature difference T_{d} may be compared to an expected temperature difference between T_{supply} and Tₜₐₙₖ at the operating conditions. If the difference between the measured temperature difference and the expected temperature difference exceeds a first threshold, an alert 148 may be triggered.

### Industrial Applicability

The systems and methods disclosed herein may be applied to any system in which oil is used as a coolant or lubricant, such as an engine system including components to which oil is supplied. The engine system 100 described in this disclosure may be installed in, for example, electrical energy generators, haul trucks, earthmoving machines, paving machines, mining machines, drilling machines, marine vessels, etc., and may be used in particular for propulsion (e.g., of a battery-powered mining haul truck) or to otherwise provide power. The engine system 100 includes an oil circuit 104 for circulating engine oil 101 to components of the engine system 100 for cooling and lubrication. The engine system 100 may comprise a controller 128 configured to identify engine oil aeration and prevent wear or inefficient operation of the engine system 100 that may result from engine oil aeration.

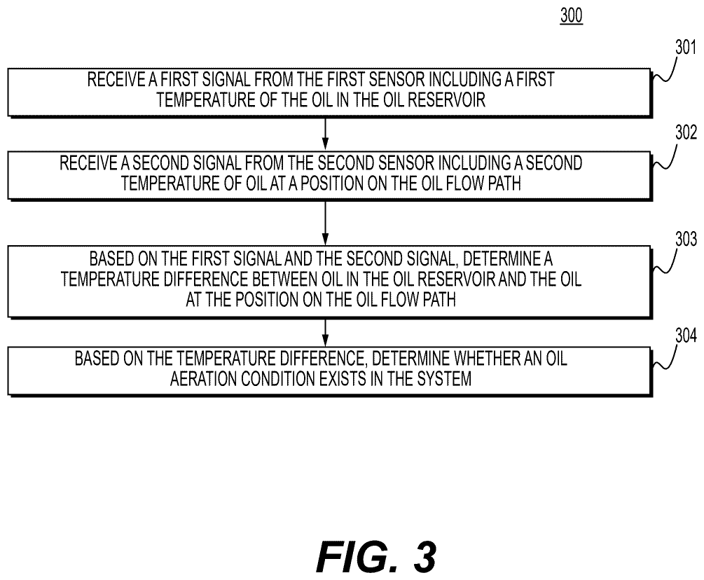

FIG. 3 provides a flowchart depicting an exemplary method 300 for detecting oil aeration in an engine system 100, according to aspects of the disclosure. At block 301, the method 300 may include receiving, with controller 128, a first signal from a first sensor including a first temperature of the oil in the oil tank. The first sensor may be the oil tank temperature sensor 134 for measuring the oil tank temperature Tₜₐₙₖ.

At block 302, the method 300 may include receiving, with controller 128, a second signal from a second sensor including a second temperature of oil at a position on an oil flow path. The second sensor may be the main oil gallery temperature sensor 136 included in the one or more main gallery sensors 126.

At block 303, the method 300 may include determining, with controller 128 and based on the first signal and the second signal, a temperature difference T_{d} between the temperature of oil in the oil reservoir (e.g., oil tank 106) and the temperature of oil at the position on the oil flow path. In general, the temperature at position in the oil flow path will be higher than the temperature in the oil tank, such that T_{d} may be calculated by subtracting Tₜₐₙₖ from T_{supply}.

At block 304, the method 300 may include determining, with aeration detector 144 of controller 128 and based on the temperature difference, whether an oil aeration condition exists in the system. This may include receiving an expected temperature difference from maps 142 for current engine conditions. The expected temperature difference from maps 142 is compared to the actual temperature difference determined in block 303.

In some aspects, the method 300 may include generating, at the aeration detector 144, an alert 148 or other indication (e.g., via an indicator or a display), of varying degrees of engine oil aeration if the difference between the actual temperature difference and the expected temperature difference exceeds one or more thresholds.

The expected temperature difference maps may include an expected temperature difference for 0% aeration, e.g., pure oil, and for a variety of different degrees of aeration. As discussed above, the temperature difference T_{d} where the oil is aerated will generally be greater than the expected temperature of non-aerated oil, where T_{d}=T_{supply}−Tₜₐₙₖ. The degree of difference between the expected T_{d} and the measured T_{d} will indicate the degree of aeration according to the expected temperature difference maps.

As discussed above, a stored maps 142 may receive, from the one or more oil tank sensors 124, a signal indicative of an oil level measurement and an oil temperature Tₜₐₙₖ at the oil tank 106, and may receive, from the main gallery temperature sensor, a signal indicative of an oil temperature T_{supply} at a supply side of the engine 102, and may receive from the sensor system 138: signals indicative of an ambient temperature, an ambient pressure, an engine jacket water temperature where the engine 102 includes an engine jacket, an engine outlet oil temperature, an engine outlet oil pressure, an engine speed, an engine tilt, and a vehicle speed where the engine 102 is driving a vehicle (not shown).

In the example described above, at one set of measurements of one or more of ambient temperature, ambient pressure, engine jacket water temperature, engine outlet oil temperature, engine outlet oil pressure, engine speed, engine tilt, and vehicle speed, the temperature difference T_{d} between the oil tank temperature Tₜₐₙₖ and the supply side temperature T_{supply}, where T_{d}=T_{supply}−Tₜₐₙₖ, may be calculated to be a first temperature difference where there is no aeration. Under the same conditions, when air is introduced, there may be a higher measured T_{d} of at a first aeration condition, and an even greater measured, T_{d} at a second aeration condition, where the second aeration condition comprises more air in the oil circuit than the first aeration condition. Multiple subsequent aeration conditions may also be identified.

As also described above, the aeration detector 144 may use the real-time measurements from the one or more oil tank sensors 124, the one or more main gallery sensors 126, and the sensor system 138 to determine real-time conditions based on real-time measurements of one or more of ambient temperature, ambient pressure, engine jacket water temperature, engine outlet oil temperature, engine outlet oil pressure, engine speed, engine tilt, and vehicle speed, the difference in temperature T_{d} between the oil tank temperature Tₜₐₙₖ and the supply side temperature T_{supply}. The real-time measurements indicate an appropriate expected temperature difference map and, in some examples, an appropriate expected oil level map for the measured conditions. The measured temperature difference T_{d} may be compared to the expected temperature difference to determine a degree of deviation. The degree of deviation may be indicative of an amount of oil aeration detected by the aeration detector 144.

For example, the aeration detector 144 may receive real-time measurements of one or more of ambient temperature, ambient pressure, engine jacket water temperature, engine outlet oil temperature, engine outlet oil pressure, engine speed, engine tilt, oil level, and vehicle speed. Based on these real-time measurements, the aeration detector may retrieve an expected temperature difference map that corresponds substantially exactly or nearly to the real-time measurements. If no temperature difference map exists for the substantially exact conditions, the aeration detector 144 or the stored maps 142 may include an algorithm for constructing an expected temperature difference map for the real-time measured conditions by extrapolation of the data in the stored expected temperature difference maps.

Upon retrieving the expected temperature difference map, the aeration detector 144 may then include instructions to compare the measured temperature difference to the expected temperature difference to determine whether an aeration condition exists, and a degree of aeration if an aeration condition exists, based on whether a first threshold, second threshold, or subsequent threshold is exceeded.

For example, if the difference between the measured temperature difference and the expected temperature difference exceeds a first threshold,, the indicator or the display may emit a visual alert (e.g., change color, flash, etc.), or emit an audible alert (e.g., beeping, siren, etc.), or emit both a visual alert and an audible alert indicating a warning condition of engine oil aeration. In one example, the indicator or the display may be green when there is no engine oil aeration detected, e.g., when there is no warning condition of engine oil aeration. The indicator or the display may transition to yellow when a first threshold is exceeded, and may further transition to red and include a flash when ta second threshold is exceeded

Additionally, the method 300 may include confirming, based on the measured oil level, whether an oil aeration condition exists in the system. Similar to the expected temperature difference maps, expected oil level maps may be generated at a variety of conditions. When there is aeration in the oil, the oil/gas mixture generally forms a foam when in the oil tank 106. This foam tends to occupy more volume than a similar amount of non-aerated oil, such that the aerated oil, in the form of foam, tends to have a higher oil level than expected at given conditions. As such, the method 300 may include measuring a real-time oil level, and comparing the real-time oil level to an expected oil level for the real-time conditions. If the real-time oil level is greater than the expected oil level, this determination may be used as further confirmation or corroboration of the determination that an engine oil aeration condition exists.

The disclosed system and method may provide techniques to detect engine oil aeration in real-time by measuring a temperature difference between a temperature at a supply side of an engine and at an engine oil tank or reservoir, and determining based on the temperature difference if an engine oil aeration condition exists. The system and method may be applied to engine systems for vehicles, such as wheel loaders or other heavy machinery, or any other engine systems that include oil circulation for cooling and lubricating engine components, such as bearings. For example, to detect engine oil aeration and prevent damage to an engine system due to decreased efficiency of aerated oil in performing its cooling and lubricating functions, a controller may receive a first signal from a first sensor including a first temperature of oil in an oil tank and receive a second signal from a second sensor including a second temperature of oil at a position on an oil flow path. Based on the first signal and the second signal, the controller may determine a temperature difference between the oil in the oil reservoir and the oil at the position on the oil flow path, and based on the temperature difference, determine whether an oil aeration condition exists in the system.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A system comprising:
an internal combustion engine;
an oil reservoir for supplying oil to the internal combustion engine;
a first sensor disposed at the oil reservoir;
a second sensor disposed at an oil flow path between the oil reservoir and the internal combustion engine; and
a controller configured to:
receive a first signal from the first sensor indicating a first temperature of the oil in the oil reservoir;
receive a second signal from the second sensor indicating a second temperature of oil at a position on the oil flow path;
based on the first signal and the second signal, determine whether an oil aeration condition exists.

2. The system of claim 1, the controller further being configured to:
retrieve an expected temperature difference between the first temperature and the second temperature;
determine, based on the first signal and the second signal, an actual temperature difference between the first temperature and the second temperature;
determine a difference between the expected temperature difference and the actual temperature difference; and
upon determining that the difference between the expected temperature difference and the actual temperature difference is greater than a first predetermined threshold, provide a first alert of a warning condition.

3. The system of claim 2, the controller further being configured to:
upon determining that the difference between the expected temperature difference and the actual temperature difference is greater than a second predetermined threshold, provide a second alert of a warning condition.

4. The system of claim 2, wherein the first predetermined threshold is based on one or more of ambient temperature, ambient pressure, engine jacket water temperature, engine oil pump output temperature, engine oil pump output pressure, oil level, engine speed, and engine tilt.

5. The system of claim 1, comprising:
a third sensor disposed at the oil reservoir, the third sensor transmitting a signal indicative of an oil level in the oil reservoir, and the controller configured to receive the third signal, and based on third signal, provide confirmation of the determination of the oil aeration condition.

6. The system of claim 5, wherein the first sensor and the third sensor are an integrated element.

7. The system of claim 5, wherein an oil aeration condition is confirmed if the oil level is higher than a predetermined threshold.

8. The system of claim 7, wherein the predetermined threshold is an expected oil level.

9. A method of detecting engine oil aeration, the method comprising:
receiving a first signal from a first sensor indicating a first temperature of oil in an oil reservoir;
receiving a second signal from a second sensor indicating a second temperature of oil at a position of an oil flow path;
based on the first signal and the second signal, determining a temperature difference between the oil in the oil reservoir and the oil at the position on the oil flow path; and
based on the temperature difference, determining whether an oil aeration condition exists in the oil.

10. The method of claim 9, further comprising:
retrieving an expected temperature difference between the first temperature and the second temperature;
determining, based on the first signal and the second signal, an actual temperature difference between the first temperature and the second temperature;
determining, a difference between the expected temperature difference and the actual temperature difference; and
upon determining that the difference between the expected temperature difference and the actual temperature difference is greater than a first predetermined threshold, providing a first alert of a warning condition.

11. The method of claim 10, further comprising:
upon determining that the difference between the expected temperature difference and the actual temperature difference is greater than a second predetermined threshold, provide a second alert of a warning condition.

12. The method of claim 10, wherein the first predetermined threshold is calculated in real-time based on one or more of ambient temperature, ambient pressure, engine jacket water temperature, engine oil pump output temperature, engine oil pump output pressure, oil level, engine speed, and engine tilt.

13. The method of claim 9, further comprising:
receiving a third signal indicative of an oil level in the oil reservoir, and based on third signal, provide confirmation of the determination of the oil aeration condition.

14. The method of claim 13, wherein an oil aeration condition is confirmed if the oil level is higher than a predetermined threshold.

15. The method of claim 14, wherein the predetermined threshold is an expected oil level.

16. A system comprising:
a first sensor configured to measure a temperature of oil in an oil reservoir;
a second sensor configured to measure a temperature of oil in an oil flow path downstream of the oil reservoir;
a controller configured to:
receive a first signal from the first sensor including a first temperature of the oil in the oil reservoir;
receive a second signal from the second sensor including a second temperature of oil at a position in the oil flow path;
based on the first signal and the second signal, determine a temperature difference between the oil in the oil reservoir and the oil at the position on the oil flow path; and
based on the temperature difference, determine whether an oil aeration condition exists in the system.

17. The system of claim 16, the controller further being configured to:
retrieve an expected temperature difference between the first temperature and the second temperature;
determine, based on the first signal and the second signal, an actual temperature difference between the first temperature and the second temperature;
determine a difference between the expected temperature difference and the actual temperature difference; and
upon determining that the difference between the expected temperature difference and the actual temperature difference is greater than a first predetermined threshold, provide a first alert of a warning condition.

18. The system of claim 17, the controller further being configured to:
upon determining that the difference between the expected temperature difference and the actual temperature difference is greater than a second predetermined threshold, provide a second alert of a warning condition.

19. The system of claim 18, wherein the first alert is a yellow indicator, and the second alert is a red indicator.

20. The system of claim 17, wherein the first predetermined threshold is calculated in real-time based on one or more of ambient temperature, ambient pressure, engine jacket water temperature, engine oil pump output temperature, engine oil pump output pressure, oil level, engine speed, and engine tilt.
